(19) United States
(12) Patent Application Publication
(10) Pub. No.: US 2008/0271463 A1
(43) Pub. Date: Nov. 6, 2008

(54) HEAT PIPE MEASURING SYSTEM

(76) Inventors: Tsz-Lang Chen, Hsinchu (TW); Ben-Mou Yu, Hsinchu (TW)

Correspondence Address: JOHN CHEN, ROOM 303, 3F, NO. 25, SEC. 1, CHANGAN E. ROAD, TAIPEI, 10441, TW

(21) Appl. No.: 11/858,885

(22) Filed: Sep. 20, 2007

Related U.S. Application Data
(60) Provisional application No. 60/915,441, filed on May 2, 2007.

(51) Int. Cl. F25B 21/02; H05B 3/02

(52) U.S. Cl. 62/3.7; 219/483

(57) ABSTRACT

The present invention provides a measuring system to determine the quality of the heat pipe, comprising a heat pipe comprising a first end connected to a first temperature sensor and a second end connected to a second temperature sensor, a heater being connected to said first end and being connected to a multi-function heater controller; a multi-function heater controller being electrically connected to said heater and said one of the first or second temperature sensor, a thermal-electric cooler (TEC) module being connected to said second end; and a TEC controller being electrically connected to said TEC module and said one of the first or second temperature sensor, wherein said TEC controller comprises a proportional-integral-derivative controller, and said multi-function heater controller comprises both constant heating power and constant temperature control modes.

This application claims priority to U.S. Provisional Patent Application Ser. No. 60/915,441 filed on the date of May 2, 2007, which is herein incorporated by reference in its entirety.

### BACKGROUND OF THE PRESENT INVENTION

1. Field of Invention

The present invention relates to a heat pipe measuring system, more particularly to a heat pipe measuring system to distinguish the quality of a heat pipe.

2. Description of Related Arts

Heat pipes are key components for heat dissipation widely used in PC, Notebooks, and game boxes nowadays. It is very difficult to distinguish the quality of the heat pipe by the appearance of the heat pipe. Thermal conductivity should be measured to determine the quality of heat pipes. The conventional heat pipe measuring systems are based on liquid circulation at the condensing side and a constant power heater at the evaporating side. They need a longer time for reaching thermal equilibrium to accomplish the measurement. Measuring inaccuracy often occurs due to the temperature instability of the liquid circulation subsystems. Maintenance of the liquid circulation subsystem is tedious and costly. In heat pipe measuring systems, especially those for mass production lines, the conventional measuring systems are slow, inaccurate, hard to maintain, and not cost-effective. Therefore, there is a request to provide a new measuring system to be fast, accurate, easy to maintain, and cost-effective.

### SUMMARY OF THE PRESENT INVENTION

The objective of the present invention is to provide a measuring system to determine the thermal conductivity of the heat pipe in a short time.

Another objective of the present invention is to provide a measuring system to determine the thermal conductivity of the heat pipe with a precise result by controlling the cooling temperature precisely and stably.

Another objective of the present invention is to provide a heat pipe measuring system which is easy to maintain for no need of liquid circulation subsystems.

In accordance with the invention, the system comprises a heat pipe comprising a first end connected to a first temperature sensor and a second end connected to a second temperature sensor; a heater being connected to said first end and being connected to a multi-function heater controller; a thermal-electric cooler (TEC) being connected to said second end; an a TEC controller being electrically connected to said TEC and said temperature sensors, wherein said TEC controller comprises a proportional-integral-derivative controller.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 illustrates an embodiment of a measuring system of the present invention.

FIG. 2 illustrates an embodiment of a TEC controller of the present invention.

FIG. 3 illustrates an embodiment of a multi-function heater controller of the present invention.

### DETAILED DESCRIPTION OF THE PREFERRED EMBODIMENTS

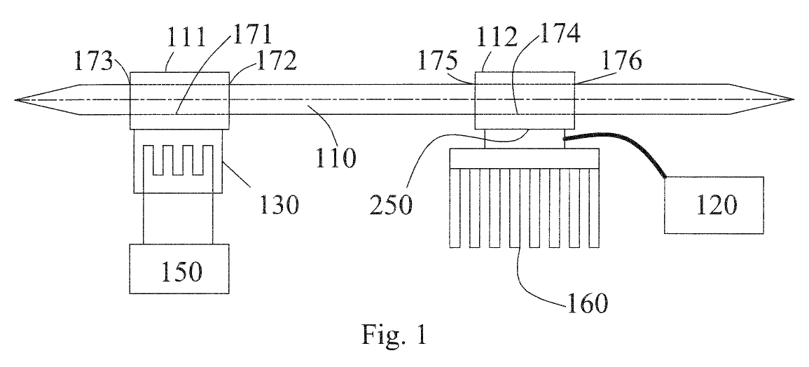

Referring to FIG. 1, it is an embodiment of a measuring system of the present invention. A heat pipe 110 is provided. The heat pipe 110 is a part of a cooling module for cooling a heat-generation device, such as a CPU. The heat pipe 110 may include a heat pipe holder 111 surrounding the evaporating side of the heat pipe 110, and the other heat pipe holder 112 surrounding the condensing side of the heat pipe 110. Both of the heat pipe holder 111 and 112 may be made by a material for good thermal conductivity, such as metal. And the heat pipe holder 111 and 112 is an important component in the measuring system.

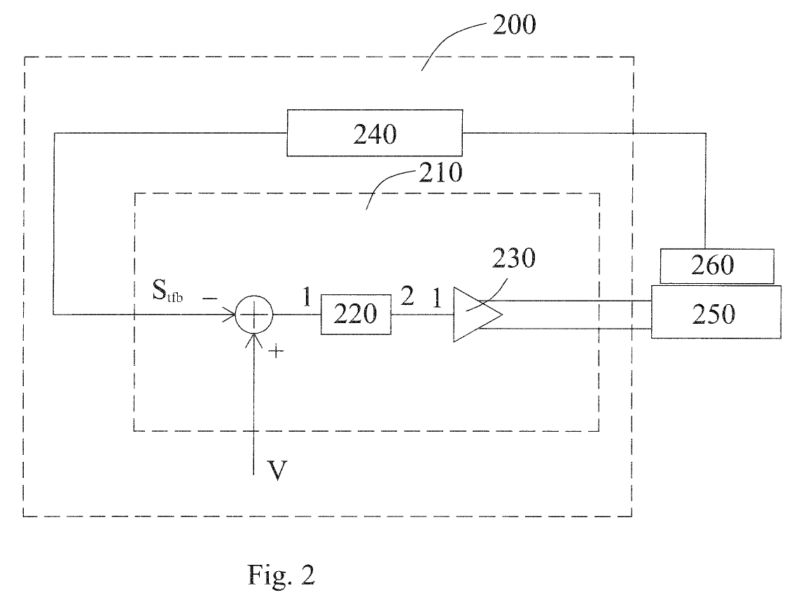

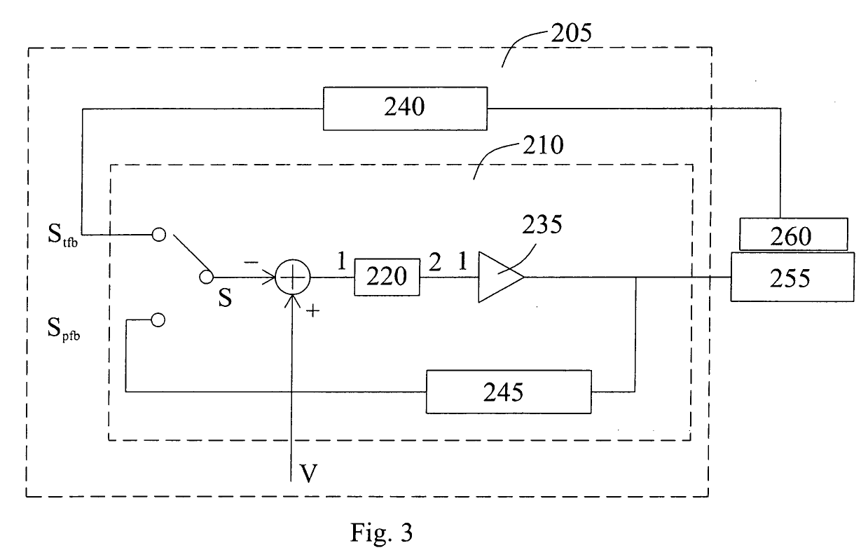

A heater 130 heats the evaporating side of the heat pipe 110 through the heat pipe holder 111. The heater 130 may generate heat by providing electric power to reach a constant temperature (FIG. 2) or a constant heating power (FIG. 3) depending on setting of the multi-function heater controller 150. A multi-function heater controller 150 controls the heater 130 either by to generate a constant heat power Q or dynamically adjust the heat power to reach a constant evaporating side temperature measured by the temperature sensor 171.

A thermal-electric cooler (TEC) module 120 cools the condensing side of the heat pipe 110 through the heat pipe holder 112. The thermal-electric cooler module 120 may include, but not limited, a matrix of the thermal-electric pellets formed on a substrate (not shown). A heat sink 160 is connected to the TEC module 120 to help radiate heat. The heat sink 160 may be but not limited to a fin-shaped metal structure (heat-exchanging structure). Any heat dissipation structure which can cooperate with TEC modules are within the consideration. Optionally, an electric fan (not shown) or water circulation can be is employed to improve the heat dissipation capacity. The temperature sensor 174 monitors the temperature caused by the TEC module 120 and the heat sink 160.

A TEC controller 140 is connected to the TEC module 120 to control the heat dissipation rate to reach a stable temperature using the feedback of the temperature sensor 174. The temperature sensors 172 (for T1) and 173 (for T1) at the evaporating side of the heat pipe 110, the former close to the end of the heat pipe 110 and the latter a little farther to the end of the heat pipe 110, measure the corresponding temperatures. The two corresponding temperatures are calculated to have the first average evaporating side temperature T1. The temperature sensors 175 (for T2) and 176 (for T2) at the condensing side of the heat pipe 110, the former close to the other end of the heat pipe 110 and the latter a little farther to the other end of the heat pipe 110, measure the corresponding temperatures. The two corresponding temperatures are calculated to have the second average condensing side temperature T2. The above calculations of T1 and T2 are examples and should not be limited to the sole definitions of temperatures of evaporating and condensing sides. Other definitions of T1 and T2 as long as one for evaporating side temperature and the other for condensing side temperature should not be regarded as departing from this invention.

The thermal conductivity K of the measured heat pipe is calculated by the formula Q=K(T1−T2). The condensing side is controlled at constant temperature by the TEC controller 140. The evaporating side can be either given a constant heat power Q or controlled at another constant temperature. The multi-function heater controller 150 can perform both control modes. K in the formal controlled mode is calculated by given Q and measured T1 and T2. In the later control mode, the multi-function heater controller 150 will measure the necessary Q. K is then found out by measured Q, T1, and T2.

Referring to FIG. 2, it is an embodiment of a TEC controller 200 of the present invention. The TEC controller 200 comprises a voltage-setting circuit 210, a proportional-integral-derivative (PID) controller 220, a bi-direction driving circuit 230, and a temperature-to-voltage converting circuit 240. The temperature sensor 260 for the TEC module 250 transports a signal of the monitored temperature to the temperature-to-voltage converting circuit 240. The temperature-to-voltage converting circuit 240 generates a corresponding voltage (Stfb, temperature feed back signal) according to the signal for the voltage-setting circuit 210. The corresponding voltage is compared with a pre-determined voltage (as V) corresponding a pre-determined temperature to generate an input signal for the PID controller 220. The PID controller 220 generates an output signal to the bi-direction driving circuit 230 and then provides the necessary current to the TEC module 250. The PID controller 220 calculates the output signal by summing the proportional gain, integration, and differentiation parts of the input signal with proper PID parameters set inside the controller. The bi-direction driving circuit 230 then transfers the PID output signal to current with a pre-determined offset. Since the TEC module 250 can be either heating or cooling the heat pipe during the whole process of measurement, the current through the TEC module 250 can be either positive or negative polarity. The bi-direction driving circuit 230 can perform such a requirement. Often the bi-direction driving circuit 230 is implemented but not limited to a pulse-width-modulated (PWM) form for high driving energy efficiency.

Referring to FIG. 3, it is an embodiment of a TEC controller 205 of the present invention. TEC controller 205 comprises a voltage-setting circuit 210, a proportional-integral-derivative (PID) controller 220, a driving circuit 235, and a temperature-to-voltage converting circuit 240, a power-to-voltage converting circuit 245. The temperature sensor 260 for the heater 255 transports a signal of the monitored temperature to the temperature-to-voltage converting circuit 240. The temperature-to-voltage converting circuit 240 generates a corresponding voltage (Stfb temperature feed back signal) according to the signal for the voltage-setting circuit 210. The corresponding voltage is compared with a pre-determined voltage (V) corresponding a pre-determined temperature to generate an input signal for the PID controller 220. Power-to-voltage converting circuit 245 generates a corresponding voltage (Spfb power feed back signal) according to the signal for the voltage-setting circuit 210. The corresponding voltage (S) is compared with a pre-determined voltage (V) corresponding a pre-determined power to generate an input signal for the PID controller 220. The PID controller 220 generates an output signal to the driving circuit 235 and then provides the necessary current to the heater 255. The PID controller 220 calculates the output signal by summing the proportional gain, integration, and differentiation parts of the input signal with proper PID parameters set inside the controller. The driving circuit 235 then transfers the PID output signal to current with a pre-determined offset. Since the heater 255 can heat the heat pipe during the whole process of measurement, the current through the driving circuit 235 can be connected to either one or another way. The driving circuit 235 can perform such a requirement. Often the driving circuit 245 is implemented but not limited to a pulse-width-modulated (PWM) form for high driving energy efficiency.

The PID controller uses well-known algorithm:

$$u ( t ) = {K}_{p} e ( t ) + {K}_{i} {\int }_{0}^{t} e ( τ ) d τ + {K}_{d} \frac{d e}{d t}$$

for optimal control, where u(t) is the output of PID controller 220, e(t) is the error signal defined as the difference between the input of voltage setting circuit 210 and either the feedback of temperature-to-voltage converting circuit 240 (constant temperature control mode) or the feedback of power-to-voltage converting circuit 245 (constant power control mode), and Kp, Ki, and Kd are proportional, integration, and differential time constants, respectively.

Although the invention has been described and illustrated with reference to specific illustrative embodiments thereof, it is not intended that the invention be limited to those illustrative embodiments. Those skilled in the art will recognize that variations and modifications can be made without departing from the spirit of the invention. It is therefore intended to include within the invention all such variations and modifications which fall within the scope of the appended claims and equivalents thereof. One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A measuring system, comprising:
a heat pipe comprising a first end connected to a first temperature sensor and a second end connected to a second temperature sensor;
a heater being connected to said first end and being connected to a heater controller; and
a controller being electrically connected to one of said first or second temperature sensors, wherein said controller comprises a proportional-integral-derivative controller for constant temperature control or constant heating power control.

2. The measuring system according to claim 1, further comprising a thermal-electric cooler being connected to said second end.

3. The measuring system according to claim 2, wherein said heat pipe is adapted for electronics cooling, and the electrics at least comprising the CPU and graphics processor of a computer, Notebook, or game machine.

4. The measuring system according to claim 2, wherein said TEC is attached to a heat sink, said heat sink comprises a heat-exchanging structure made by metal.

5. The measuring system according to claim 2, wherein said heat pipe comprises a first metal structure surrounding said first end to attach to said heater.

6. The measuring system according to claim 2, wherein said heat pipe comprises a second metal structure surrounding said second end to attach to said controller.

7. A measuring method comprising steps of:
providing a heat pipe;
heating a first end of said heat pipe by a heater; and
measuring a first temperature at said first end, and measuring a second temperature at said second end by a plurality of temperature sensors respectively.

8. The measuring method according to claim 7, further comprising a step before the measuring step for the temperature, cooling a second end of said heat pipe by a thermal-electric cooler (TEC).

9. The measuring method according to claim 7, wherein said TEC is connected to a TEC controller, said TEC controller comprises a proportional-integral-derivative controller.

10. The measuring method according to claim 7, wherein said heater is connected to a multi-function heater controller either providing a constant heat power or doing constant temperature control.
